(19) United States
(12) Patent Application Publication
(10) Pub. No.: US 2010/0306032 A1
(43) Pub. Date: Dec. 2, 2010

(54) Systems and Methods to Summarize Transaction Data

(75) Inventor: Ryan Bradford Jolley, San Mateo, CA (US)

Correspondence Address: Greenberg Traurig, LLP (VISA);IP Docketing, 2450 Colorado Avenue, Suite 400E, Santa Monica, CA, 90404, US

(73) Assignee: VISA U.S.A., San Francisco, CA (US)

(21) Appl. No.: 12/777,173

(22) Filed: May 10, 2010

Related U.S. Application Data
(60) Provisional application No. 61/182,806, filed on Jun. 1, 2009.

(51) Int. Cl. G06F 17/30; G06Q 10/00

(52) U.S. Cl. 705/10; 705/30; 707/603; 707/737; 707/E17.047

(57) ABSTRACT

Systems and methods to summarize transaction data via cluster analysis and factor analysis. In one aspect, a method includes identifying at least one set of clusters based on a cluster analysis of transaction records to group entities, identifying a plurality of factors based on a factor analysis of the transaction records to reduce correlations in spending variables, classifying an entity according to the at least one set of clusters, and computing values of the factors based on the transaction records of the entity.

### RELATED APPLICATIONS

The present application claims priority to U.S. Provisional Pat. App. Ser. No. 61/182,806, filed Jun. 1, 2009, the disclosure of which is incorporated herein by reference.

The present application relates to copending U.S. patent application Ser. No. 12/537,566, filed Aug. 7, 2009, the disclosure of which is incorporated herein by reference.

### FIELD OF THE TECHNOLOGY

At least some embodiments of the present disclosure relate to the processing of transaction data, such as records of payments made via credit cards, debit cards, prepaid cards, etc.

### BACKGROUND

Millions of transactions occur daily through the use of payment cards, such as credit cards, debit cards, prepaid cards, etc. Corresponding records of the transactions are recorded in databases for settlement and financial recordkeeping (e.g., to meet the requirements of government regulations). Such data can be mined and analyzed for trends, statistics, and other analyses. Sometimes such data are mined for specific advertising goals, such as to provide targeted offers to accountholders, as described in PCT Pub. No. WO 2008/067543 A2, published on Jun. 5, 2008 and entitled “Techniques for Targeted Offers,” the disclosure of which is hereby incorporated herein by reference.

A typical transaction record includes data corresponding to one transaction. The transaction record can include a date and time at which the transaction was made, a cardholder account identifier (e.g., an account number of a customer), a merchant identifier (e.g., a name and address of the merchant, a unique merchant number, or a categorical grouping), the geographic location (e.g., the city or zip code) of the transaction, the amount of the transaction and whether it was a debit or credit. Other data can also be recorded, such as the channel type of the transaction (e.g., whether the transaction was made online, by phone, or offline) or whether there was a currency conversion.

Although indicated as “card” transactions, card transactions described herein can take place without a physical card. A card can assume forms other than a physical card, such as a virtual card or number indicating an account. Likewise, “cardholders” may not physically own a card but may simply have access to or be authorized to use the virtual card or number indicating an account.

A cardholder or other accountholder can be a natural person, business entity, or any other organization which is associated with using the account to cause transactions and make payments on the account.

### BRIEF DESCRIPTION OF THE DRAWINGS

The embodiments are illustrated by way of example and not limitation in the figures of the accompanying drawings in which like references indicate similar elements.

FIG. 1 illustrates the generation of an aggregated spending profile according to one embodiment.

FIG. 2 shows a method to generate an aggregated spending profile according to one embodiment.

FIG. 3 shows a system to generate and summarize transaction data according to one embodiment.

FIG. 4 illustrates a data processing system according to one embodiment.

### DETAILED DESCRIPTION

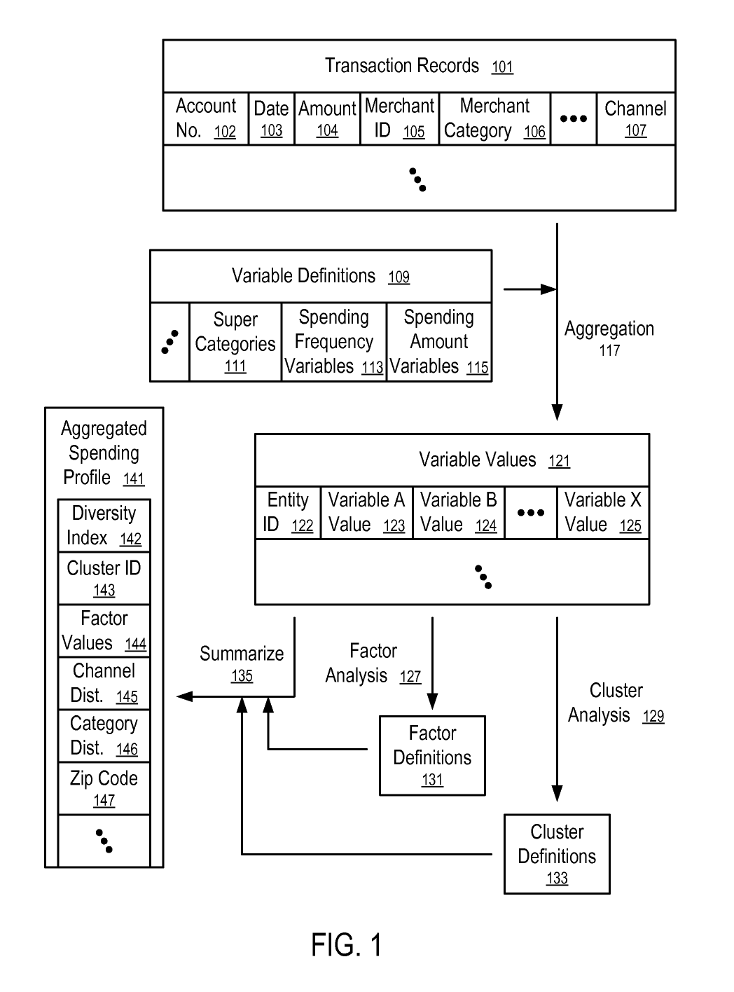

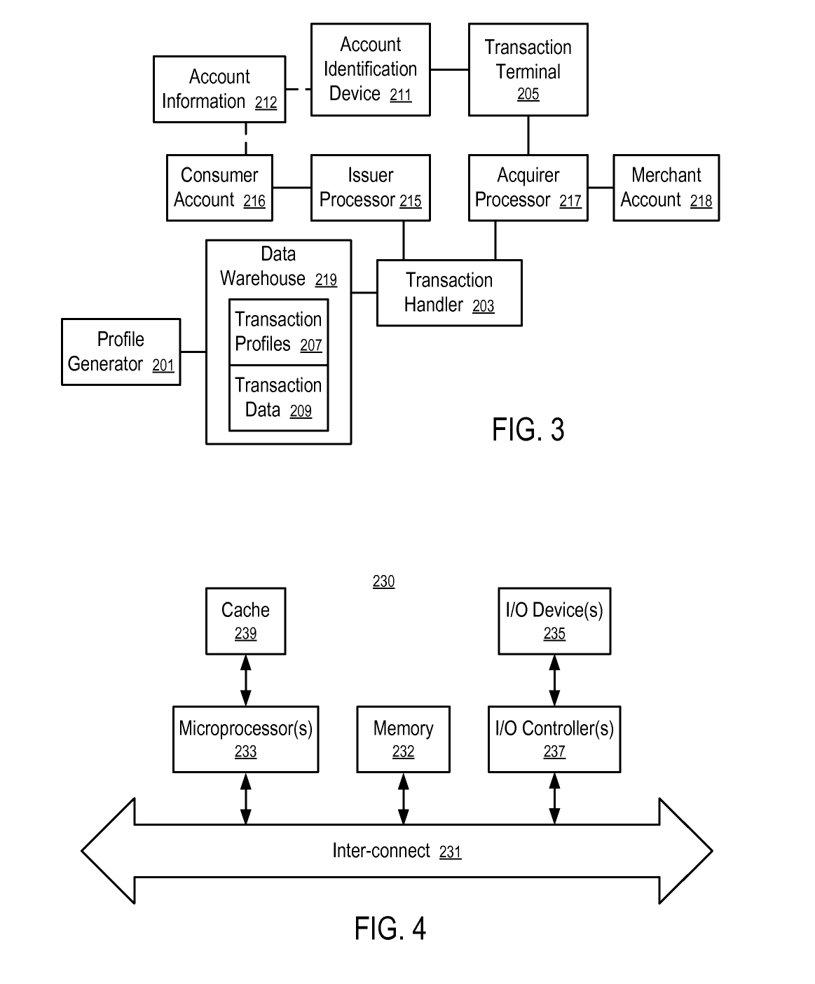

In one embodiment, as illustrated in FIG. 3, transaction data (209) is accumulated in the data warehouse (219) as the transaction handler (203) processes payment transactions between customers and merchants, such as credit card transactions and debit card transactions. The sheer volume of card transaction records and the number of fields collected for each record may pose a problem. The transaction data (209) in its raw form can be cumbersome for certain analyses or for projects on shortened timelines. In FIG. 3, a profile generator (201) analyzes the transaction data (209) to generate transaction profiles (207), such as an aggregated spending profile (141) illustrated in FIG. 1.

In one embodiment, the characteristics of transaction patterns of customers are profiled via clusters, factors, and/or categories of purchases. The transaction data (209), such as the transaction records (101) illustrated in FIG. 1 is analyzed to generate an aggregated spending profile (141) to summarize the spending behaviors and/or spending patterns reflected in the transaction records (101).

In FIG. 1, each of the transaction records (101) is for a particular transaction processed by the transaction handler (203). Each of the transaction records (101) provides information about the particular transaction, such as the account number (102) of the consumer account (216) used to pay for the purchase, the date (103) (and/or time) of the transaction, the amount (104) of the transaction, the ID (105) of the merchant who receives the payment, the category (106) of the merchant, the channel (107) through which the purchase was made, etc. Examples of channels include online, offline in-store, via phone, etc. In some embodiments, the transaction records (101) may further include a field to identify a type of transaction, such as card-present, card-not-present, etc.

In one embodiment, a “card-present” transaction involves physically presenting the account identification device (211), such as a financial transaction card, to the merchant (e.g., via swiping a credit card at a POS terminal of a merchant); and a “card-not-present” transaction involves presenting the account information (212) of the consumer account (216) to the merchant to identify the consumer account (216) without physically presenting the account identification device (211) to the merchant or the transaction terminal (205).

In some embodiments, certain information about the transaction can be looked up in a separate database based on other information recorded for the transaction. For example, a database may be used to store information about merchants, such as the geographical locations of the merchants, categories of the merchants, etc. Thus, the corresponding merchant information related to a transaction can be determined using the merchant ID (105) recorded for the transaction.

In some embodiments, the transaction records (101) may further include details about the products and/or services involved in the purchase. For example, a list of items purchased in the transaction may be recorded together with the respective purchase prices of the items and/or the respective quantities of the purchased items. The products and/or services can be identified via Stock-Keeping Unit (SKU) numbers, or product category IDs. The purchase details may be stored in a separate database and be looked up based on an identifier of the transaction.

When there is voluminous data representing the transaction records (101), the spending patterns reflected in the transaction records (101) can be difficult to recognize by an ordinary person.

In one embodiment, the voluminous transaction records (101) are summarized (135) into aggregated spending profiles (e.g., 141) to concisely present the statistical spending characteristics reflected in the transaction records (101). The aggregated spending profile (141) uses values derived from statistical analysis to present the statistical characteristics of transaction records (101) of an entity in a way easy to understand and use by an ordinary person.

In FIG. 1, the transaction records are summarized (135) via factor analysis (127) to condense the variables (e.g., 113, 115) and via cluster analysis (129) to segregate entities by spending patterns.

In FIG. 1, a set of variables (e.g., 311, 313, 315) are defined based on the parameters recorded in the transaction records (101). The variables (e.g., 311, 313, and 315) are defined in a way to have meanings easily understood by an ordinary person. For example, variables (111) measure the aggregated spending in super categories; variables (113) measure the spending frequencies in various areas; and variables (115) measure the spending amounts in various areas. In one embodiment, each of the areas is identified by a merchant category (106) (e.g., as represented by a merchant category code (MCC), a North American Industry Classification System (NAICS) code, or a similarly standardized category code). In other embodiments, an area may be identified by a product category, a SKU number, etc.

In some embodiments, a variable of a same category (e.g., frequency (113) or amount (115)) are defined to be aggregated over a set of mutually exclusive areas. A transaction is classified in only one of the mutually exclusive areas. For example, in one embodiment, the spending frequency variables (113) are defined for a set of mutually exclusive merchants or merchant categories. Transactions falling with the same category are aggregated.

Some examples of the spending frequency variables (113) and spending amount variables (115) defined for various merchant categories (e.g., 306) can be found in U.S. patent application Ser. No. 12/537,566, filed Aug. 7, 2009 and entitled “Cardholder Clusters,” and in Prov. U.S. Pat. App. Ser. No. 61/182,806, filed Jun. 1, 2009 and entitled “Cardholder Clusters,” the disclosures of which applications are incorporated herein by reference.

In some embodiments, super categories (111) are defined to group the categories (e.g., 106) used in transaction records (101). The super categories (111) can be mutually exclusive. For example, each merchant category (106) is classified under only one super merchant category but not any other super merchant categories. Since the generation of the list of super categories typically requires deep domain knowledge about the businesses of the merchants in various categories, super categories (111) are not used in some embodiments.

In one embodiment, the aggregation (117) includes the application of the definitions (109) for these variables (e.g., 311, 313, and 315) to the transaction records (101) to generate the variable values (121). The transaction records (101) are aggregated to generate aggregated measurements (e.g., variable values (121)) that are not specific for a particular transaction, such as frequencies of purchases made with different merchants or different groups of merchants, the amounts spent with different merchants or different groups of merchants, and the number of unique purchases across different merchants or different groups of merchants, etc. The aggregation (117) can be performed for a particular time period and for entities at various levels.

In one embodiment, the transaction records (101) are aggregated according to a buying entity. The aggregation (117) can be performed at account level, person level, family level, company level, neighborhood level, city level, region level, etc. to analyze the spending patterns across various areas (e.g., sellers, products or services) for the respective aggregated buying entity. For example, the transaction records (101) for a particular account (e.g., presented by the account number (102)) can be aggregated for an account level analysis. To aggregate the transaction records in account level, the transactions with a specific merchant or merchants in a specific category are counted according to the variable definitions (109) for a particular account to generate a frequency measure (e.g., 313) for the account relative to the specific merchant or merchant category; and the transaction amounts (e.g., 104) with the specific merchant or the specific category of merchants are summed for the particular account to generate an average spending amount for the account relative to the specific merchant or merchant category. For example, the transaction records (101) for a particular person having multiple accounts can be aggregated for a person level analysis, the transaction records (101) aggregated for a particular family for a family level analysis, and the transaction records (101) for a particular business aggregated for a business level analysis.

The aggregation (117) can be performed for a predetermined time period, such as for the transactions occurring in the past month, in the past three months, in the past twelve months, etc.

In another embodiment, the transaction records (101) are aggregated according to a selling entity. The spending patterns at the selling entity across various buyers, products or services can be analyzed. For example, the transaction records (101) for a particular merchant having transactions with multiple accounts can be aggregated for a merchant level analysis. For example, the transaction records (101) for a particular merchant group can be aggregated for a merchant group level analysis.

In one embodiment, the aggregation (117) is formed separately for different types of transactions, such as transactions made online, offline, via phone, and/or “card-present” transactions vs. “card-not-present” transactions, which can be used to identify the spending pattern differences among different types of transaction.

In one embodiment, the variable values (e.g., 123, 124, . . . , 125) associated with an entity ID (122) are considered the random samples of the respective variables (e.g., 311, 313, 315), sampled for the instance of an entity represented by the entity ID (122). Statistical analyses (e.g., factor analysis (127) and cluster analysis (129)) are performed to identify the patterns and correlations in the random samples.

For example, a cluster analysis (129) can identify a set of clusters and thus cluster definitions (133) (e.g., the locations of the centroids of the clusters). In one embodiment, each entity ID (122) is represented as a point in a mathematical space defined by the set of variables; and the variable values (123, 124, . . . , 125) of the entity ID (122) determine the coordinates of the point in the space and thus the location of the point in the space. Various points may be concentrated in various regions; and the cluster analysis (129) is configured to formulate the positioning of the points to drive the clustering of the points. In other embodiments, the cluster analysis (129) can also be performed using the techniques of Self Organizing Maps (SOM), which can identify and show clusters of multi-dimensional data using a representation on a two-dimensional map.

Once the cluster definitions (133) are obtained from the cluster analysis (129), the identity of the cluster (e.g., cluster ID (143)) that contains the entity ID (122) can be used to characterize spending behavior of the entity represented by the entity ID (122). The entities in the same cluster are considered to have similar spending behaviors.

Similarities and differences among the entities, such as accounts, individuals, families, etc., as represented by the entity ID (e.g., 122) and characterized by the variable values (e.g., 123, 124, . . . , 125) can be identified via the cluster analysis (129). In one embodiment, after a number of clusters of entity IDs are identified based on the patterns of the aggregated measurements, a set of profiles can be generated for the clusters to represent the characteristics of the clusters. Once the clusters are identified, each of the entity IDs (e.g., corresponding to an account, individual, family) can be assigned to one cluster; and the profile for the corresponding cluster may be used to represent, at least in part, the entity (e.g., account, individual, family). Alternatively, the relationship between an entity (e.g., an account individual, family) and one or more clusters can be determined (e.g., based on a measurement of closeness to each cluster). Thus, the cluster related data can be used in a transaction profile (207 or 141) to provide information about the behavior of the entity (e.g., an account, an individual, a family).

In one embodiment, more than one set of cluster definitions (133) is generated from cluster analyses (129). For example, cluster analyses (129) may generate different sets of cluster solutions corresponding to different numbers of identified clusters. A set of cluster IDs (e.g., 143) can be used to summarize (135) the spending behavior of the entity represented by the entity ID (122), based on the typical spending behavior of the respective clusters. In one example, two cluster solutions are obtained; one of the cluster solutions has 17 clusters, which classify the entities in a relatively coarse manner; and the other cluster solution has 55 clusters, which classify the entities in a relative fine manner. A cardholder can be identified by the spending behavior of one of the 17 clusters and one of the 55 clusters in which the cardholder is located. Thus, the set of cluster IDs corresponding to the set of cluster solutions provides a hierarchical identification of an entity among clusters of different levels of resolution. The spending behavior of the clusters is represented by the cluster definitions (133), such as the parameters (e.g., variable values) that define the centroids of the clusters.

In one embodiment, the random variables (e.g., 313 and 315) as defined by the definitions (109) have certain degrees of correlation and are not independent from each other. For example, merchants of different merchant categories (e.g., 106) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user from making a purchase from another merchant). Such relationships may be complex and difficult to quantify by merely inspecting the categories. Further, such relationships may shift over time as the economy changes.

In one embodiment, a factor analysis (127) is performed to reduce the redundancy and/or correlation among the variables (e.g., 313, 315). The factor analysis (127) identifies the definitions (131) for factors, each of which represents a combination of the variables (e.g., 313, 315).

In one embodiment, a factor is a linear combination of a plurality of the aggregated measurements (e.g., variables (113, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (207 or 141) to provide information on the behavior of the entity represented by the entity ID (e.g., an account, an individual, a family).

Once the factor definitions (131) are obtained from the factor analysis (127), the factor definitions (131) can be applied to the variable values (121) to determine factor values (144) for the aggregated spending profile (141). Since redundancy and correlation are reduced in the factors, the number of factors is typically much smaller than the number of the original variables (e.g., 313, 315). Thus, the factor values (144) represent the concise summary of the original variables (e.g., 313, 315).

For example, there may be thousands of variables on spending frequency and amount for different merchant categories; and the factor analysis (127) can reduce the factor number to less than one hundred (and even less than twenty). In one example, a twelve-factor solution is obtained, which allows the use of twelve factors to combine the thousands of the original variables (113, 315); and thus, the spending behavior in thousands of merchant categories can be summarized via twelve factor values (144). In one embodiment, each factor is combination of at least four variables; and a typical variable has contributions to more than one factor.

In one example, hundreds or thousands of transaction records (101) of a cardholder are converted into hundreds or thousands of variable values (121) for various merchant categories, which are summarized (135) via the factor definitions (131) and cluster definitions (133) into twelve factor values (144) and one or two cluster IDs (e.g., 143). The summarized data can be readily interpreted by a human to ascertain the spending behavior of the cardholder. A user may easily specify a spending behavior requirement formulated based on the factor values (144) and the cluster IDs (e.g., to query for a segment of customers, or to request the targeting of a segment of customers). The reduced size of the summarized data reduces the need for data communication bandwidth for communicating the spending behavior of the cardholder over a network connection, and allows simplified processing and utilization of the data representing the spending behavior of the cardholder.

In one embodiment, the behavior and characteristics of the clusters are studied to identify a description of a type of representative entities that are found in each of the clusters. The clusters can be named based on the type of representative entities to allow an ordinary person to easily understand the typical behavior of the cluster.

In one embodiment, the behavior and characteristics of the factors are also studied to identify dominant aspects of each factor. The clusters can be named based on the dominant aspects to allow an ordinary person to easily understand the meaning of a factor value.

In FIG. 1, an aggregated spending profile (141) for an entity represented by an entity ID (e.g., 122) includes the cluster ID (143) and factor values (144) determined based on the cluster definitions (133) and the factor definitions (131). The aggregated spending profile (141) may further include other statistical parameters, such as diversity index (142), channel distribution (145), category distribution (146), zip code (147), etc., as further discussed below.

In one embodiment, the diversity index (142) may include an entropy value and/or a Gini coefficient, to represent the diversity of the spending by the entity represented by the entity ID (122) across different areas (e.g., different merchant categories (e.g., 106)). When the diversity index (142) indicates that the diversity of the spending data is under a predetermined threshold level, the variable values (e.g., 123, 124, . . . , 125) for the corresponding entity ID (122) may be excluded from the cluster analysis (129) and/or the factor analysis (127) due to the lack of diversity. When the diversity index (142) of the aggregated spending profile (141) is lower than a predetermined threshold, the factor values (144) and the cluster ID (143) may not accurately represent the spending behavior of the corresponding entity.

In one embodiment, the channel distribution (145) includes a set of percentage values that indicate the percentages of amounts spent in different purchase channels, such as online, via phone, in a retail store, etc.

In one embodiment, the category distribution (146) includes a set of percentage values that indicate the percentages of spending amounts in different super categories (111). In one embodiment, thousands of different merchant categories (e.g., 106) are represented by Merchant Category Codes (MCC), or North American Industry Classification System (NAICS) codes in transaction records. These merchant categories (e.g., 106) are classified or combined into less than one hundred super categories (or less than twenty). In one example, fourteen super categories are defined based on domain knowledge.

In one embodiment, the aggregated spending profile (141) includes the aggregated measurements (e.g., frequency, average spending amount) determined for a set of predefined, mutually exclusive merchant categories (e.g., super categories (111)). Each of the super merchant categories represents a type of products or services a customer may purchase. A transaction profile (207 or 141) may include the aggregated measurements for each of the set of mutually exclusive merchant categories. The aggregated measurements determined for the predefined, mutually exclusive merchant categories can be used in transaction profiles (207 or 141) to provide information on the behavior of a respective entity (e.g., account, an individual, or a family).

In one embodiment, the zip code (147) in the aggregated spending profile (141) represents the dominant geographic area in which the spending associated with the entity ID (122) occurred. Alternatively or in combination, the aggregated spending profile (141) may include a distribution of transaction amounts over a set of zip codes that account for a majority of the transactions or transaction amounts (e.g., 90%).

In one embodiment, the factor analysis (127) and cluster analysis (129) are used to summarize the spending behavior across various areas, such as different merchants characterized by merchant category (106), different products and/or services, different consumers, etc. The aggregated spending profile (141) may include more or fewer fields than those illustrated in FIG. 1. For example, in one embodiment, the aggregated spending profile (141) further includes an aggregated spending amount for a period of time (e.g., the past twelve months); in another embodiment, the aggregated spending profile (141) does not include the category distribution (146); and in a further embodiment, the aggregated spending profile (141) may include a set of distance measures to the centroids of the clusters. The distance measures may be defined based on the variable values (123, 124, . . . , 125), or based on the factor values (144). The factor values of the centroids of the clusters may be estimated based on the entity ID (e.g., 122) that is closest to the centroid in the respective cluster.

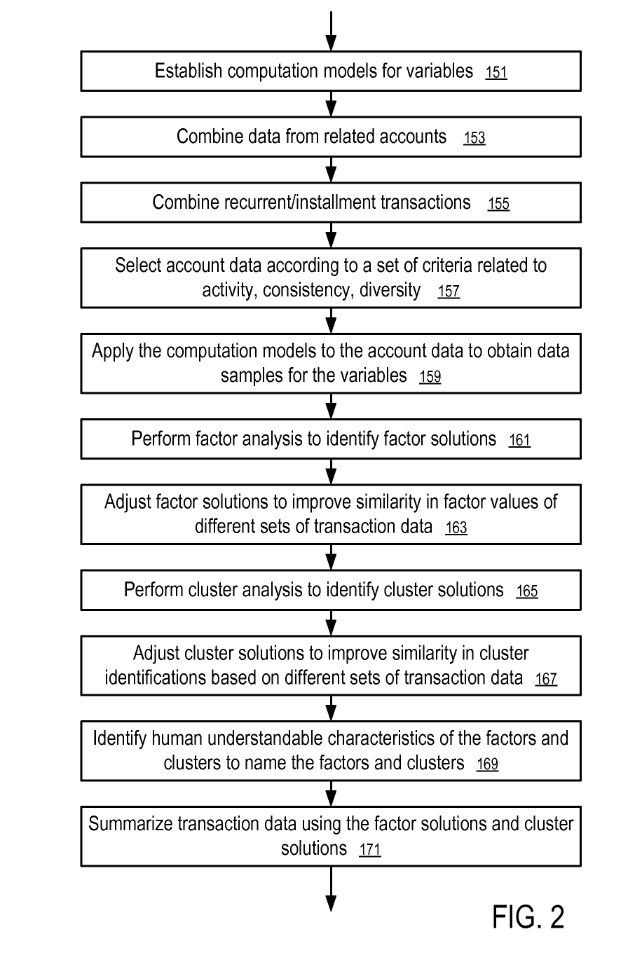

FIG. 2 shows a method to generate an aggregated spending profile according to one embodiment. In FIG. 2, computation models are established (151) for variables (e.g., 311, 313, and 315). In one embodiment, the variables are defined in a way to capture certain aspects of the spending statistics, such as frequency, amount, etc.

In FIG. 2, data from related accounts are combined (153). For example, when an account number change has occurred for a cardholder in the time period under analysis, the transaction records under the different account numbers of the same cardholder are combined under one account number that represents the cardholder. For example, when the analysis is performed at a person level (or family level, business level, social group level, city level, or region level), the transaction records in different accounts of the person (or family, business, social group, city or region) can be combined under one entity ID (122) that represents the person (or family, business, social group, city or region).

In one embodiment, recurrent/installment transactions are combined (155). For example, multiple monthly payments may be combined and considered as one single purchase.

In FIG. 2, account data are selected (157) according to a set of criteria related to activity, consistency, diversity, etc.

For example, when a cardholder uses a credit card solely to purchase gas, the diversity of the transactions by the cardholder is low. In such a case, the transactions in the account of the cardholder may not be statistically meaningful to represent the spending pattern of the cardholder in various merchant categories. Thus, in one embodiment, if the diversity of the transactions associated with an entity ID (122) is below a threshold, the variable values (e.g., 123, 124, . . . , 125) corresponding to the entity ID (122) are not used in the cluster analysis (129) and/or the factor analysis (127). The diversity can be examined based on the diversity index (142) (e.g., entropy or Gini coefficient), or based on counting the different merchant categories in the transactions associated with the entity ID (122); and when the count of different merchant categories is fewer than a threshold (e.g., 5), the transactions associated with the entity ID (122) are not used in the cluster analysis (129) and/or the factor analysis (127) due to the lack of diversity.

For example, when a cardholder uses a credit card only sporadically (e.g., when running out of cash), the limited transactions by the cardholder may not be statistically meaningful in representing the spending behavior of the cardholder. Thus, in one embodiment, when the numbers of transactions associated with an entity ID (122) is below a threshold, the variable values (e.g., 123, 124, . . . , 125) corresponding to the entity ID (122) are not used in the cluster analysis (129) and/or the factor analysis (127).

For example, when a cardholder has only used a credit card during a portion of the time period under analysis, the transaction records during the time period may not reflect the consistent behavior of the cardholder for the entire time period. Consistency can be checked in various ways. In one example, if the total number of transactions during the first and last months of the time period under analysis is zero, the transactions associated with the entity ID (122) are inconsistent in the time period and thus are not used in the cluster analysis (129) and/or the factor analysis (127). Other criteria can be formulated to detect inconsistency in the transactions.

In FIG. 2, the computation models (e.g., as represented by the variable definitions (109)) are applied (159) to the remaining account data (e.g., transaction records (101)) to obtain data samples for the variables. The data points associated with the entities, other than those whose transactions fail to meet the minimum requirements for activity, consistency, diversity, etc., are used in factor analysis (127) and cluster analysis (129).

In FIG. 2, the data samples (e.g., variable values (121)) are used to perform (161) factor analysis (127) to identify factor solutions (e.g., factor definitions (131)). The factor solutions can be adjusted (163) to improve similarity in factor values of different sets of transaction data. For example, factor definitions (131) can be applied to the transactions in the time period under analysis (e.g., the past twelve months) and be applied separately to the transactions in a prior time period (e.g., the twelve months before the past twelve months) to obtain two sets of factor values. The factor definitions (131) can be adjusted to improve the correlation between the two set of factor values.

The data samples can also be used to perform (165) cluster analysis (129) to identify cluster solutions (e.g., cluster definitions (133)). The cluster solutions can be adjusted (167) to improve similarity in cluster identifications based on different sets of transaction data. For example, cluster definitions (133) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (133) can be adjusted to improve the correlation between the two set of cluster identifications.

In one embodiment, the number of clusters is determined from clustering analysis. For example, a set of cluster seeds can be initially identified and used to run a known clustering algorithm. The sizes of data points in the clusters are then examined. When a cluster contains less than a predetermined number of data points, the cluster may be eliminated to rerun the clustering analysis.

In one embodiment, standardizing entropy is added to the cluster solution to obtain improved results.

In one embodiment, human understandable characteristics of the factors and clusters are identified (169) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (127) and the cluster analysis (129) are performed periodically (e.g., once a year, or six months) to update the factor definitions (131) and the cluster definitions (133), which may change as the economy and the society change over time.

In FIG. 2, transaction data are summarized (171) using the factor solutions and cluster solutions to generate the aggregated spending profile (141). The aggregated spending profile (141) can be updated more frequently than the factor solutions and cluster solutions, when the new transaction data becomes available. For example, the aggregated spending profile (141) may be updated quarterly or monthly.

Various tweaks and adjustments can be made for the variables (e.g., 313, 315) used for the factor analysis (127) and the cluster analysis (129). For example, the transaction records (101) may be filtered, weighted or constrained, according to different rules to improve the capabilities of the aggregated measurements in indicating certain aspects of the spending behavior of the customers.

For example, in one embodiment, the variables (e.g., 313, 315) are normalized and/or standardized (e.g., using statistical average, mean, and/or variance).

For example, the variables (e.g., 313, 315) for the aggregated measurements can be tuned, via filtering and weighting, to predict the future trend of spending behavior (e.g., for advertisement selection), to identify abnormal behavior (e.g., for fraud prevention), or to identify a change in spending pattern (e.g., for advertisement audience measurement), etc. The aggregated measurements, the factor values (144), and/or the cluster ID (143) generated from the aggregated measurements can be used in a transaction profile (207 or 141) to define the behavior of an account, an individual, a family, etc.

In some embodiments, the transaction data are aged to provide more weight to recent data than older data. In other embodiments, the transaction data are reverse aged. In further embodiments, the transaction data are seasonally adjusted.

In one embodiment, the variables (e.g., 313, 315) are constrained to eliminate extreme outliers. For example, the minimum values and the maximum values of the spending amounts (115) may be constrained based on values at certain percentiles (e.g., the value at one percentile as the minimum and the value at 99 percentile as the maximum) and/or certain predetermined values. In one embodiment, the spending frequency variables (113) are constrained based on values at certain percentiles and median values. For example, the minimum value for a spending frequency variable (313) may be constrained at P₁−k×(M−P₁), where P₁ is the one percentile value, M the median value, and k a predetermined constant (e.g., 0.1). For example, the maximum value for a spending frequency variable (313) may be constrained at P₉₉+a×(P₉₉−M), where P₉₉ is the 99 percentile value, M the median value, and k a predetermined constant (e.g., 0.1).

In one embodiment, variable pruning is performed to reduce the number of variables (e.g., 313, 315) that have less impact on cluster solutions and/or factor solutions. For example, variables with standard variation less than a predetermined threshold (e.g., 0.1) may be discarded for the purpose of cluster analysis (129). For example, analysis of variance (ANOVA) can be performed to identify and remove variables that are no more significant than a predetermined threshold.

The aggregated spending profile (141) can provide information on spending behavior for various application areas, such as marketing, fraud detection and prevention, creditworthiness assessment, loyalty analytics, targeting of offers, etc.

For example, clusters can be used to optimize offers for various groups within an advertisement campaign. The use of factors and clusters to target advertisement can improve the speed of producing targeting models. For example, using variables based on factors and clusters (and thus eliminating the need to use a large number of convention variables) can improve predictive models and increase efficiency of targeting by reducing the number of variables examined. The variables formulated based on factors and/or clusters can be used with other variables to build predictive models based on spending behaviors.

In one embodiment, the aggregated spending profile (141) can be used to monitor risks in transactions. Factor values are typically consistent over time for each entity. An abrupt change in some of the factor values may indicate a change in financial conditions, or a fraudulent use of the account. Models formulated using factors and clusters can be used to identify a series of transactions that do not follow a normal pattern specified by the factor values (144) and/or the cluster ID (143). Potential bankruptcies can be predicted by analyzing the change of factor values over time; and significant changes in spending behavior may be detected to stop and/or prevent fraudulent activities.

For example, the factor values (144) can be used in regression models and/or neural network models for the detection of certain behaviors or patterns. Since factors are relatively non-collinear, the factors can work well as independent variables. For example, factors and clusters can be used as independent variables in tree models.

For example, surrogate accounts can be selected for the construction of a quasi-control group. For example, for a given account A that is in one cluster, the account B that is closest to the account A in the same cluster can be selected as a surrogate account of the account B. The closeness can be determined by certain values in the aggregated spending profile (141), such as factor values (144), category distribution (146), etc. For example, a Euclidian distance defined based on the set of values from the aggregated spending profile (141) can be used to compare the distances between the accounts. Once identified, the surrogate account can be used to reduce or eliminate bias in measurements. For example, to determine effect of an advertisement, the spending pattern response of the account A that is exposed to the advertisement can be compared to the spending pattern response of the account B that is not exposed to the advertisement.

For example, the aggregated spending profile (141) can be used in segmentation and/or filtering analysis, such as selecting cardholders having similar spending behaviors identified via factors and/or clusters for targeted advertisement campaigns, and selecting and determining a group of merchants that could be potentially marketed towards cardholders originating in a given cluster (e.g., for bundled offers). For example, a query interface can be provided to allow the query to identify a targeted population based on a set of criteria formulated using the values of clusters and factors.

For example, the aggregated spending profile (141) can be used in a spending comparison report, such as comparing a sub-population of interest against the overall population, determining how cluster distributions and mean factor values differ, and building reports for merchants and/or issuers for benchmarking purposes. For example, reports can be generated according to clusters in an automated way for the merchants. For example, the aggregated spending profile (141) can be used in geographic reports by identifying geographic areas where cardholders shop most frequently and comparing predominant spending locations with cardholder residence locations.

FIG. 3 shows a system to generate and summarize transaction data according to one embodiment. In FIG. 3, the transaction handler (203) is coupled between an issuer processor (215) and an acquirer processor (217) to facilitate authorization and settlement of transactions between a consumer account (216) and a merchant account (218). The transaction handler (203) records the transaction data (209) about the transactions in the data warehouse (219). The profile generator (201) analyzes the transaction data (209) to generate the transaction profile (207).

In FIG. 3, the consumer account (216) is under the control of the issuer processor (215). The consumer account (216) may be owned by an individual, or an organization such as a business, a school, etc. The consumer account (216) may be a credit account, a debit account, or a stored value account. The issuer may provide the consumer an account identification device (211) to identify the consumer account (216) using the account information (212). The respective consumer of the account (216) can be called an account holder or a cardholder, even when the consumer is not physically issued a card, or the account identification device (211), in one embodiment. The issuer processor (215) is to charge the consumer account (216) to pay for purchases.

In one embodiment, the account identification device (211) is a plastic card having a magnetic strip storing account information (212) identifying the consumer account (216) and/or the issuer processor (215). Alternatively, the account identification device (211) is a smartcard having an integrated circuit chip storing at least the account information (212). In one embodiment, the account identification device (211) includes a mobile phone having an integrated smartcard.

In one embodiment, the account information (212) is printed or embossed on the account identification device (211). The account information (212) may be printed as a bar code to allow the transaction terminal (205) to read the information via an optical scanner. The account information (212) may be stored in a memory of the account identification device (211) and configured to be read via wireless, contactless communications, such as near field communications via magnetic field coupling, infrared communications, or radio frequency communications. Alternatively, the transaction terminal may require contact with the account identification device (211) to read the account information (212) (e.g., by reading the magnetic strip of a card by a magnetic stripe reader).

In one embodiment, the transaction terminal (205) is configured to transmit an authorization request message to the acquirer processor (217). The authorization request includes the account information (212), an amount of payment, and information about the merchant (e.g., an indication of the merchant account (218)). The acquirer processor (217) requests the transaction handler (203) to process the authorization request, based on the account information (212) received in the transaction terminal (205). The transaction handler (203) routes the authorization request to the issuer processor (215) and may process and respond to the authorization request when the issuer processor (215) is not available. The issuer processor (215) determines whether to authorize the transaction based at least in part on a balance of the consumer account (216).

In one embodiment, the transaction handler (203), the issuer processor (215), and the acquirer processor (217) may each include a subsystem to identify the risk in the transaction and may reject the transaction based on the risk assessment.

In one embodiment, the account identification device (211) includes security features to prevent unauthorized uses of the consumer account (216), such as a logo to show the authenticity of the account identification device (211), encryption to protect the account information (212), etc.

In one embodiment, the transaction terminal (205) is configured to interact with the account identification device (211) to obtain the account information (212) that identifies the consumer account (216) and/or the issuer processor (215). The transaction terminal (205) communicates with the acquirer processor (217) that controls the merchant account (218) of a merchant. The transaction terminal (205) may communicate with the acquirer processor (217) via a data communication connection, such as a telephone connection, an Internet connection, etc. The acquirer processor (217) is to collect payments into the merchant account (218) on behalf of the merchant.

In one embodiment, the transaction terminal (205) is a POS terminal at a traditional, offline, “brick and mortar” retail store. In another embodiment, the transaction terminal (205) is an online server that receives account information (212) of the consumer account (216) from the user through a web connection. In one embodiment, the user may provide account information (212) through a telephone call, via verbal communications with a representative of the merchant; and the representative enters the account information (212) into the transaction terminal (205) to initiate the transaction.

In one embodiment, the account information (212) can be entered directly into the transaction terminal (205) to make payment from the consumer account (216), without having to physically present the account identification device (211). When a transaction is initiated without physically presenting an account identification device (211), the transaction is classified as a “card-not-present” (CNP) transaction.

In one embodiment, the issuer processor (215) may control more than one consumer account (216); the acquirer processor (217) may control more than one merchant account (218); and the transaction handler (203) is connected between a plurality of issuer processors (e.g., 215) and a plurality of acquirer processors (e.g., 217). An entity (e.g., bank) may operate both an issuer processor (215) and an acquirer processor (217).

In one embodiment, the transaction handler (203), the issuer processor (215), the acquirer processor (217), the transaction terminal (205), and other devices are connected via communications networks, such as local area networks, cellular telecommunications networks, wireless wide area networks, wireless local area networks, an intranet, and Internet. In one embodiment, dedicated communication channels are used between the transaction handler (203) and the issuer processor (215), between the transaction handler (203) and the acquirer processor (217), and/or between the profile generator (201) and the transaction handler (203).

In one embodiment, the transaction handler (203) includes a powerful computer, or cluster of computers functioning as a unit, controlled by instructions stored on a computer readable medium.

In one embodiment, the transaction handler (203) is configured to support and deliver authorization services, exception file services, and clearing and settlement services. In one embodiment, the transaction handler (203) has a subsystem to process authorization requests and another subsystem to perform clearing and settlement services.

In one embodiment, the transaction handler (203) is configured to process different types of transactions, such credit card transactions, debit card transactions, prepaid card transactions, and other types of commercial transactions.

In one embodiment, the transaction handler (203) facilitates the communications between the issuer processor (215) and the acquirer processor (217).

In one embodiment, the transaction terminal (205) is configured to submit the authorized transactions to the acquirer processor (217) for settlement. The amount for the settlement may be different from the amount specified in the authorization request. The transaction handler (203) is coupled between the issuer processor (215) and the acquirer processor (217) to facilitate the clearing and settling of the transaction. Clearing includes the exchange of financial information between the issuer processor (215) and the acquirer processor (217); and settlement includes the exchange of funds.

In one embodiment, the issuer processor (215) is to provide funds to make payments on behalf of the consumer account (216). The acquirer processor (217) is to receive the funds on behalf of the merchant account (218). The issuer processor (215) and the acquirer processor (217) communicate with the transaction handler (203) to coordinate the transfer of funds for the transaction. In one embodiment, the funds are transferred electronically.

In some embodiments, the transaction terminal (205) may submit a transaction directly for settlement, without having to separately submit an authorization request.

In one embodiment, the transaction terminal (205) includes a reader configured to interact with the account identification device (211) to obtain account information (212) about the consumer account (216).

In one embodiment, the reader includes a magnetic strip reader. In another embodiment, the reader includes a contactless reader, such as a radio frequency identification (RFID) reader, a near field communications (NFC) device configured to read via magnetic field coupling (in accordance with ISO standard 14443/NFC), a Bluetooth transceiver, a WiFi transceiver, an inferred transceiver, a laser scanner, etc.

In one embodiment, the transaction terminal (205) includes an input device, such as key buttons that can be used to enter the account information (212) directly into the transaction terminal (205) without the physical presence of the account identification device (211). The input device can be configured to provide further information to initiate a transaction, such as a personal identification number (PIN), password, zip code, etc. that may be used to access the account identification device (211), or in combination with the account information (212) obtained from the account identification device (211).

In one embodiment, the transaction terminal (205) includes an input device, such as a display, a speaker, and/or a printer to present information, such as the result of an authorization request, a receipt for the transaction, an advertisement, etc.

In one embodiment, the transaction terminal (205) includes a network interface configured to communicate with the acquirer processor (217) via a telephone connection, an Internet connection, or a dedicated data communication channel.

In one embodiment, the transaction terminal (205) includes a memory storing the instructions configured at least to cause the transaction terminal (205) to send an authorization request message to the acquirer processor (217) to initiate a transaction. The transaction terminal (205) may or may not send a separate request for the clearing and settling of the transaction. The instructions stored in the memory (232) are also configured to cause the transaction terminal (205) to perform other types of functions discussed in this description.

In some embodiments, a transaction terminal (205) is configured for “card-not-present” transactions; and the transaction terminal (205) does not have a reader.

In some embodiments, a transaction terminal (205) may have more components, such as transaction terminals (205) configured as ATM machines, which include components to dispense cash under certain conditions.

In one embodiment, the account identification device (211) is configured to carry account information (212) that identifies the consumer account (216). For example, the account identification device (211) may include a memory coupled to the processor, which controls the operations of a communication device, an input device, an audio device and a display device. The memory may store instructions for the processor and/or data, such as the account information (212) associated with the consumer account (216).

In one embodiment, the account information (212) includes an identifier identifying the issuer (and thus the issuer processor (215)) among a plurality of issuers, and an identifier identifying the consumer account among a plurality of consumer accounts controlled by the issuer processor (215). The account information (212) may include an expiration date of the account identification device (211), the name of the consumer holding the consumer account (216), and/or an identifier identifying the account identification device (211) among a plurality of account identification devices associated with the consumer account (216).

In one embodiment, the account information (212) may further include a loyalty program account number, accumulated rewards of the consumer in the loyalty program, an address of the consumer, a balance of the consumer account (216), transit information (e.g., a subway or train pass), access information (e.g., access badges), and/or consumer information (e.g., name, date of birth), etc.

In some embodiments, the information stored in the memory of the account identification device (211) may also be in the form of data tracks that are traditionally associated with credits cards. Such tracks include Track 1 and Track 2. Track 1 (International Air Transport Association) stores more information than Track 2, and contains the cardholder's name as well as the account number and other discretionary data. Track 1 is sometimes used by airlines when securing reservations with a credit card. Track 2 (American Banking Association) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the account identification device (211) includes a communication device, such as a semiconductor chip, to implement a transceiver for communication with the reader and an antenna to provide and/or receive wireless signals.

In one embodiment, the communication device of the account identification device (211) is configured to communicate with the reader of the transaction terminal (205). The communication device may include a transmitter to transmit the account information (212) via wireless transmissions, such as radio frequency signals, magnetic coupling, or inferred, Bluetooth or WiFi signals, etc.

In one embodiment, the account identification device (211) is in the form of a mobile phone, personal digital assistant (PDA), etc. The input device can be used to provide input to the processor to control the operation of the account identification device (211); and the audio device and the display device may present status information and/or other information, such as advertisements or offers. The account identification device (211) may include further components, such as a cellular communications subsystem.

In one embodiment, an account identification device (211) is in the form of a debit card, a credit card, a smartcard, or a consumer device that has optional features such as magnetic strips, or smartcards.

An example of an account identification device (211) is a magnetic strip attached to a plastic substrate in the form of a card. The magnetic strip is used as the memory (232) of the account identification device (211) to provide the account information (212). Consumer information, such as account number, expiration date, and consumer name may be printed or embossed on the card. A semiconductor chip implementing the memory (232) and the communication device may also be embedded in the plastic card to provide account information (212) in one embodiment. In some embodiments, the account identification device (211) has the semiconductor chip but not the magnetic strip.

In one embodiment, the account identification device (211) is integrated with a security device, such as an access card, a radio frequency identification (RFID) tag, a security card, a transponder, etc.

In one embodiment, the account identification device (211) is a handheld and compact device. In one embodiment, the account identification device (211) has a size suitable to be placed in a wallet or pocket of the consumer.

Some examples of an account identification device (211) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (212).

In one embodiment, a computing apparatus is configured to include some of the modules or components illustrated in FIG. 3, such as the transaction handler (203), the profile generator (201), and their associated storage devices, such as the data warehouse (219).

In one embodiment, at least some of the modules or components illustrated in FIG. 3, such as the transaction handler (203), the transaction terminal (205), the transaction profiles (207), the profile generator (201), the issuer processor (215), the acquirer processor (217), the account identification device (211), and the transaction terminal (205), can be implemented as a computer system, such as a data processing system illustrated in FIG. 4, with more or fewer components. Some of the modules may share the hardware or be combined on a computer system. In some embodiments, a network of computers can be used to implement one or more of the modules.

FIG. 4 illustrates a data processing system according to one embodiment. While FIG. 4 illustrates various components of a computer system, it is not intended to represent any particular architecture or manner of interconnecting the components. Some embodiments may use other systems that have fewer or more components than those shown in FIG. 4.

In FIG. 4, the data processing system (230) includes an inter-connect (231) (e.g., bus and system core logic), which interconnects a microprocessor(s) (233) and memory (232). The microprocessor (233) is coupled to cache memory (239) in the example of FIG. 4.

In one embodiment, the inter-connect (231) interconnects the microprocessor(s) (233) and the memory (232) together and also interconnects them to input/output (I/O) device(s) (235) via I/O controller(s) (237). I/O devices (235) may include a display device and/or peripheral devices, such as mice, keyboards, modems, network interfaces, printers, scanners, video cameras and other devices known in the art. In some embodiments, when the data processing system is a server system, some of the I/O devices (235), such as printers, scanners, mice, and/or keyboards, are optional.

In one embodiment, the inter-connect (231) includes one or more buses connected to one another through various bridges, controllers and/or adapters. In one embodiment the I/O controllers (237) include a USB (Universal Serial Bus) adapter for controlling USB peripherals, and/or an IEEE-1394 bus adapter for controlling IEEE-1394 peripherals.

In one embodiment, the memory (232) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs. The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

This description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by some embodiments and not by others. Similarly, various requirements are described which may be requirements for some embodiments but not other embodiments. Unless excluded by explicit description and/or apparent incompatibility, any combination of various features described in this description is also included here.

It should be understood that at least some embodiments as described above can be implemented in the form of control logic using computer software in a modular or integrated manner. Based on the disclosure and teachings provided herein, a person of ordinary skill in the art will know and appreciate other ways and/or methods to implement the embodiments using hardware or a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
receiving in a computing device a plurality of transaction records; and
generating, using the computing device, a transaction profile to summarize the transaction records, the transaction profile including a plurality of factor values computed respectively for a plurality of factors defined based on a factor analysis.

2. The method of claim 1, wherein the plurality of transaction records relate to payments made by a first entity.

3. The method of claim 2, further comprising:
identifying a second entity based on similarity in transaction profile between the first entity and the second entity.

4. The method of claim 2, wherein the transaction profile further includes first data identifying among a first set of clusters a first cluster to which the first entity belongs; wherein the first set of clusters group entities based on first spending behaviors reflected in transaction records of the entities.

5. The method of claim 4, wherein the transaction profile further includes second data identifying among a second set of clusters a second cluster to which the first entity belongs; wherein the second set of clusters group the entities based on second spending behaviors reflected in the transaction records of the entities.

6. The method of claim 4, further comprising:
identifying characteristics of the first set of clusters via a cluster analysis of the transaction records of the entities; and
identifying the first cluster based on the plurality of transaction records and the characteristics of the first set of clusters.

7. The method of claim 6, wherein the characteristics of the first set of clusters are based on centroids of the first set of clusters.

8. The method of claim 6, further comprising:
selecting the entities based on requirements on activity, consistency and diversity in the transaction records of the entities.

9. The method of claim 6, further comprising:
adjusting the characteristics of the first set of clusters to improve correlation between clusters identified based on the transaction records of the entities and clusters identified based on a separate set of transaction records of the entities.

10. The method of claim 4, further comprising:
identifying the plurality of factors via a factor analysis of the transaction records of the entities.

11. The method of claim 10, further comprising:
naming the factors and the clusters based on identifying human understandable characteristics of spending behaviors represented by the factors and the clusters.

12. The method of claim 10, further comprising:
adjusting definitions of the factors to improve correlation between factor values computed based on the transaction records of the entities and factor values computed based on a separate set of transaction records of the entities.

13. The method of claim 10, wherein each of the plurality of factors is a combination of a plurality of variables; and the combination is determined from the factor analysis to reduce correlation among the plurality of factors.

14. The method of claim 13, wherein each of the plurality of factors is a combination of at least four variables.

15. The method of claim 14, wherein each of the plurality of variables indicates one of: a frequency of purchases from a predefined category of merchants and an amount of purchases from a predefined category of merchants.

16. The method of claim 15, wherein each of the plurality of variables is normalized using statistics of the transaction records of the entities.

17. The method of claim 4, wherein the transaction profile further includes at least one of: an indication of a geographical area in which most of offline transactions in the plurality of transaction records occurred, at least one indicator of merchant diversity in the plurality of transaction records, and data representing a distribution of amounts of purchases across of a set of channels through which transactions in the plurality of transaction records occurred.

18. The method of claim 17, wherein the indication of the geographical area comprises a postal code.

19. A computer-readable storage medium storing instructions, the instructions causing a computer to perform a method, the method comprising:
processing a plurality of transaction records; and
generating a transaction profile to summarize the transaction records, the transaction profile including a plurality of factor values computed respectively for a plurality of factors defined based on a factor analysis.

20. An apparatus, comprising:
a data warehouse to store a set of transaction records of a plurality of entities, including a plurality of transaction records of a first entity; and
at least one processor coupled to the data warehouse to generate a transaction profile to summarize the transaction records of the first entity, the transaction profile including a plurality of factor values computed respectively for a plurality of factors defined based on a factor analysis of the set of transaction records.
